(19) United States
(12) Patent Application Publication
(10) Pub. No.: US 2025/0300872 A1
(43) Pub. Date: Sep. 25, 2025

(54) RECONFIGURABLE SIGNAL ACQUISITION

(71) Applicant: BAE Systems Information and Electronic Systems Integration Inc., Nashua, NH (US)

(72) Inventor: Michael N. Kloos, Atkins, IA (US)

(73) Assignee: BAE Systems Information and Electronic Systems Integration Inc., Nashua, NH (US)

(21) Appl. No.: 19/078,436

(22) Filed: Mar. 13, 2025

Related U.S. Application Data
(60) Provisional application No. 63/568,087, filed on Mar. 21, 2024.

(51) Int. Cl. H04L 27/26

(52) U.S. Cl. CPC H04L 27/2657

(57) ABSTRACT

A signal acquisition device includes an acquisition processor configured in a first modality, to correlate a set of RF signal samples across a plurality of time offset windows, wherein there are n streams and each of the n streams has a same frequency offset and a different time offset, and in a second modality, to correlate the set of RF signal samples across a plurality of frequency offset windows, wherein there are n streams and each of the n streams has a same time offset and a different frequency offset.

### CROSS REFERENCE TO RELATED APPLICATION

The present application claims the benefit of U.S. Provisional Patent Application No. 63/568,087, filed Mar. 21, 2024, which is incorporated by reference herein in its entirety.

### FIELD OF DISCLOSURE

The present disclosure relates to signal processing techniques, and more particularly, to techniques for reconfigurable signal acquisition.

### BACKGROUND

Signals transmitted through space are subject to propagation (time) delays, Doppler (frequency shift) effects, and noise. A receiver may have difficulty locating a signal of interest when such modifications to the signal are unknown and unpredictable. Thus, there are non-trivial issues relating to the acquisition of these signals.

### BRIEF DESCRIPTION OF THE DRAWINGS

FIG. 1 is a block diagram of a satellite system, in accordance with an example of the present disclosure.

FIG. 2 is a block diagram of the receiver of the system of FIG. 1, in accordance with an example of the present disclosure.

FIG. 3 is a block diagram of a signal acquisition search engine of the receiver of FIG. 2, in accordance with an example of the present disclosure.

FIGS. 4 and 5 depict a signal search space for performing a search across both time and frequency uncertainty, in accordance with an example of the present disclosure.

FIGS. 6, 7, and 8 illustrate example operation modes of the signal acquisition search engine of FIG. 3, in accordance with an example of the present disclosure.

FIGS. 9 and 10 show a comparison between a true chipping frequency of an incoming signal to the receiver of FIG. 2, versus a compressed or expanded chipping sequence of the incoming signal, in accordance with an example of the present disclosure.

FIGS. 11A and 11B each illustrate an example of uncompensated code slide, in accordance with an example of the present disclosure.

FIG. 12 is a diagram of operation of code slide compensation, in accordance with an example of the present disclosure.

FIG. 13 is a block diagram of a processing platform configured to provide a system for signal acquisition, in accordance with an example of the present disclosure.

Although the following detailed description refers to illustrative examples, many alternatives, modifications, and variations thereof will be apparent in light of this disclosure.

### DETAILED DESCRIPTION

Techniques are provided herein for signal acquisition. In an example, a signal acquisition device includes an acquisition processor configured, in a first modality, to correlate a set of RF signal samples across a plurality of time offset windows, where there are n streams and each of the n streams has a same frequency offset and a different time offset, and, in a second modality, to correlate the set of RF signal samples across a plurality of frequency offset windows, where there are n streams and each of the n streams has a same time offset and a different frequency offset.

In another example, the acquisition processor is configured, in a first modality, to correlate a set of RF signal samples at a first rate, where the set of RF signal samples include M-code signals, and, in a second modality, to correlate the set of RF signal samples at a second rate that is greater than the first rate, where the set of RF signal samples includes non-M-code signals.

In yet another example, the acquisition processor is configured, in a first modality, to correlate a set of RF signal samples across a plurality of time offset windows, wherein there are n streams and each of the n streams has a same frequency offset and a different time offset, and, in a second modality, to correlate the set of RF signal samples across a plurality of frequency offset windows, wherein there are n streams, where one-half of the n streams have a same time offset and a first frequency offset, and where another one-half of the n streams have a same time offset and a second frequency offset that is one-half of a frequency bit offset from the first frequency offset.

### Overview

Various systems transmit signals encoded with information over the air or through space (e.g., wirelessly). The signals can, for example, include data (such as a code) encoded and modulated onto a carrier frequency for transmission, sometimes with further in-phase and quadrature (IQ) encoding to help the receiver decode the data rapidly, accurately, and reliably. Signal acquisition by a receiver involves inspecting potential signals for the presence of a code. However, as noted above, the arrival of the code may be delayed by an unpredictable amount or shifted in frequency by an unpredictable amount. Code uncertainty is the uncertainty of the time delay (e.g., propagation delay) of a code in a received signal. Frequency uncertainty is the uncertainty of the Doppler frequency shift of the code in the received signal. Such uncertainties give rise to variability and unpredictability, therefore increasing the amount of space needed to search for the signals of interest.

### Example System

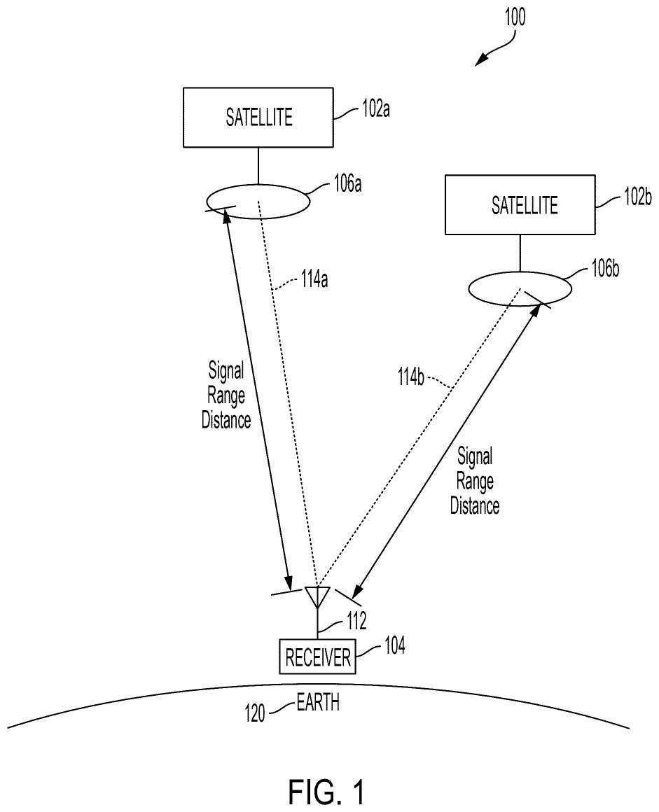

FIG. 1 is a block diagram of a satellite system 100, in accordance with an example of the present disclosure. The system 100 includes satellite platforms 102a, 102b and a receiver 104. Other such examples may have only one satellite platform such as 102a or 102b, while still other examples may include satellite platforms 102a and 102b as well as one more additional satellite platforms. Each satellite platform 102a, 102b has at least one transmit antenna 106a, 106b. The receiver 104 has a receive antenna 112 for receiving signals transmitted from the transmit antenna 106a, 106b.

The satellite platforms 102a, 102b are in an orbit around the Earth 120, such as a geostationary orbit, a medium earth orbit (MEO), or a low Earth orbit (LEO). The receiver 104 can be located, for example, on land, in air, or at sea, and may be part of a stationary or mobile platform (e.g., vehicle, ship, aircraft). The satellite platforms 102a, 102b are each configured to transmit at least one signal 114a, 114b from the transmit antenna 106a, 106b. The receiver 104 is configured to receive and process the signals 114a, 114b for, among other things, determining the geolocation of the receiver 104 or receiving other information from the satellite platforms 102a, 102b.

The range distances of the signals 114a, 114b can change with respect to the receiver 104, depending on the orientation and position of the transmit antennas 106a, 106b with respect to the receive antenna 112. Furthermore, the range distances of the signals 114a, 114b can change continuously as the satellite platforms 102a, 102b move relative to the receiver 104, which induces a propagation delay as well as a Doppler shift.

The receiver 104 may be configured to measure the range of the signals 114a, 114b to very fine resolution. Often measurement noise of only a few millimeters is possible for a GPS carrier phase, while tens of centimeters can be achieved in the GPS code phase (pseudo-range) measurement. This level of accuracy is sufficient for the receiver 104 to observe the time offset and Doppler shift of the signals 114a, 114b as the satellite platforms 102a, 102b change orientation with respect to the location of the receiver 104. Note that the signals 114a, 114b can be received at the receiver 104 contemporaneously (overlapping in time). Such contemporaneous reception of the signals 114a, 114b is also referred to as a multi-burst signal. Therefore, the receiver 104 is also configured to discriminate the signals 114a, 114b from each other as well as from contemporaneous signals and noise received from other sources.

### Receiver With Signal Acquisition Search Engine

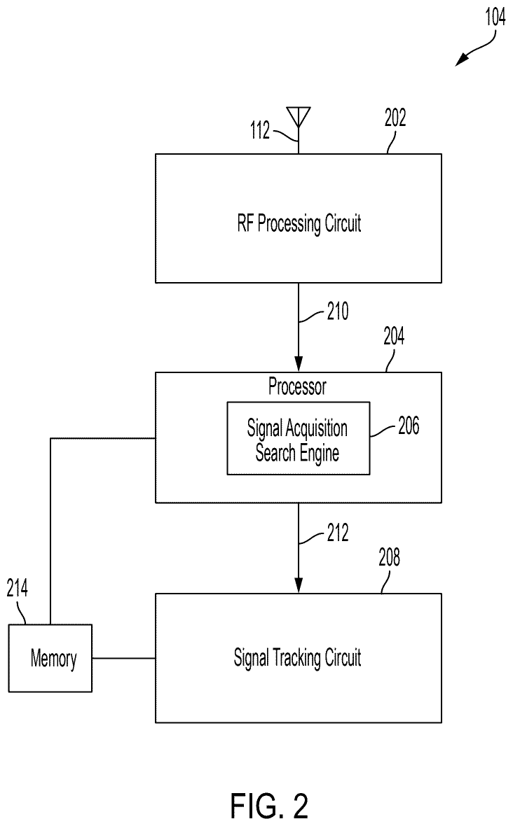

FIG. 2 is a block diagram of the receiver 104, in accordance with an example of the present disclosure. The receiver 104 includes, or is operatively coupled to, the antenna 112. The receiver 104 includes a radio frequency (RF) processing circuit 202, a processor 204, such as an application-specific integrated circuit (ASIC) or a field programmable gate array (FPGA) having a signal acquisition search engine 206, and a signal tracking circuit 208. The signal acquisition search engine 206 may also be referred to herein as a signal acquisition device or apparatus.

The RF processing circuit 202 is configured to provide the signals 114a, 114b from the receive antenna 112 to the processor 204. The RF processing circuit 202 may be implemented with any number of RF frontend architectures. For example, the RF processing circuit 202 can include a low noise amplifier, a mixer, a filter, automatic gain control circuit, an RF downconverter, an analog-to-digital signal converter/sampler, and a digital signal processor. In operation, the RF processing circuit 202 converts the RF signals (e.g., the signals 114a, 114b) from analog to a sampled digital signal 210 for further processing by the processor 204. The sampled digital signal 210 can be a complex signal, also referred to as an in-phase/quadrature (IQ) signal. The signals 114a, 114b include a code that uniquely identifies a satellite (e.g., the satellite platforms 102a, 102b) transmitting the signals 114a, 114b from the transmit antennas 106a, 106b onboard the satellites. It will be understood that the RF processing circuit 202 can be further configured to process other signals received via the receive antenna 112 from additional satellites.

The processor 204 is configured to receive the sampled digital signal 210 and to produce an output signal 212 for further processing by the signal tracking circuit 208. The output signal 212 can include, for example, a magnitude of a peak bin (tone), adjacent bin magnitudes, received signal strengths, and/or other information used to track the signals 114a, 114b. As described in further detail below, the signal acquisition search engine 206, which is integrated into the processor 204 in this example embodiment, uses a correlation-based computation to detect the presence of a signal with a known or pre-determined form or code within the sampled digital signal 210. Correlation is the process of measuring the similarity between the sampled digital signal 210, which is incoming to the receiver 104, and a set of known signals, also referred to herein as tones and codes. Such correlation detection is useful for acquiring signals in environments where multiple signals are received contemporaneously and where the signals of interest may be obscured by noise and Doppler effects.

In general, the correlation is a value representing the product of the sampled digital signal 210 (which is unknown) and one or more generated tones and/or codes summed over an interval. The correlation value thus represents the similarity of the sampled digital signal 210 to the tones and codes, where low correlation values (e.g., approaching zero) represent dissimilar signals that are unlikely to be signals of interest for acquisition, and high correlation values represent higher levels of similarity that are more likely to be signals of interest for acquisition.

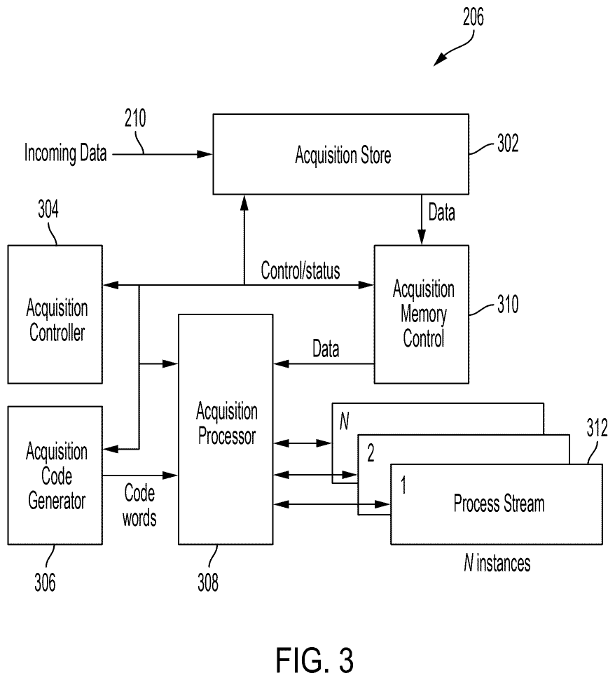

FIG. 3 is a block diagram of the signal acquisition search engine 206, in accordance with an example of the present disclosure. The acquisition search engine 206 includes an acquisition store 302 for storing incoming data, such as the sampled digital signal 210 (including, for instance, I and Q data). The acquisition search engine 206 further includes an acquisition controller 304, an acquisition code generator 306, an acquisition processor 308, and an acquisition memory control 310. In operation, the acquisition search engine 206 receives the sampled digital signal 210 and at least temporarily stores it in the acquisition store 302. The acquisition controller 304 causes the acquisition memory control 310 to send the sampled digital signal 210 from the acquisition store 302 to the acquisition processor 308. The acquisition processor 308 correlates the sampled digital signal 210 with one or more codes generated by the acquisition code generator 306. The acquisition search engine 206 performed the correlations as one or more process streams 312, as described in further detail below.

### Correlation and Time/Frequency Search Space

The signal acquisition search engine 206 correlates samples of a received signal at different times and at different frequencies against replicas of the expected code to determine whether the code is likely to be present at a given time and frequency. Acquiring a signal can include searching across various frequencies and attempting to correlate the received signals at each frequency with an expected pattern to identify the signal. For example, one such search strategy includes searching each of several frequency ranges for a signal of interest all possible time phases, one frequency range at a time. This process is repeated until all of the frequency ranges have been completely searched, thus covering all possible signal time and frequency uncertainty.

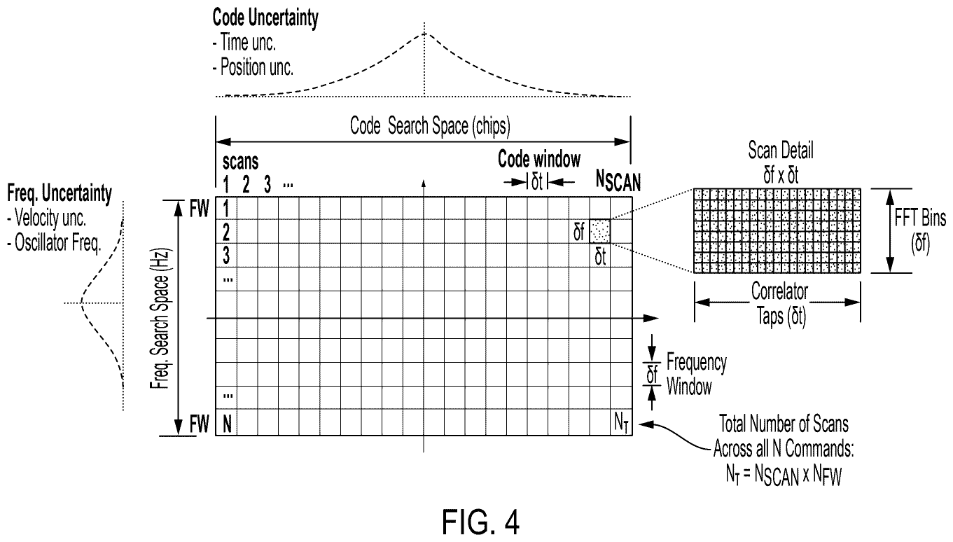

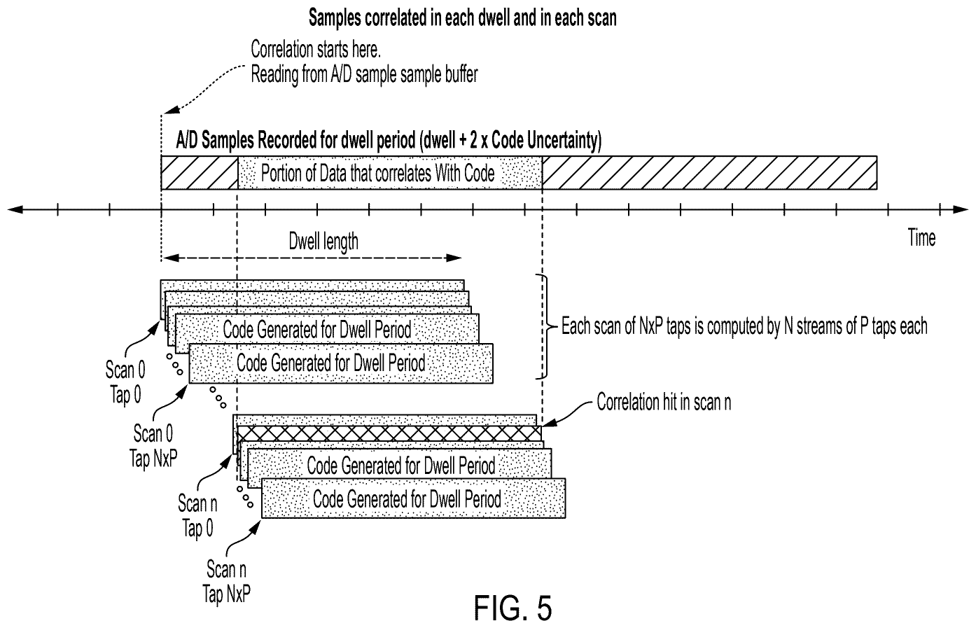

An example of such a search space is depicted in FIG. 4, in which a search is performed across both time and frequency uncertainty. In FIG. 4, the search space is two-dimensional: a code search space (horizontal axis) and a frequency search space (vertical). The search space is divided into code and frequency windows. Each scan of the incoming signal (each code and frequency window) is processed by the acquisition processor 308 for M frequency bins and NₓP correlation taps of code phase uncertainty. The NₓP taps (horizontal axis) include N streams of P taps, as shown in FIG. 5. The first stream includes taps 0 to P-1, the second stream includes taps P to 2P-1, and so forth. Each tap is correlated over all samples per dwell period, where the dwell period is the amount of time required to determine whether a code is present in the signal.

So-called brute force techniques can be utilized to locate and acquire signals that have unknown or unpredictable delays and shifts in both the time and frequency domains, thus creating a very large space to be searched. This is particularly true where there is position, navigation, and timing (PNT) uncertainty induced by relative changes in positions between the transmitter and the receiver. However, such brute force techniques are computationally expensive and not well suited for certain applications such as those where size, weight, power, and/or cost are important factors in the design of a system. In some circumstances, signal acquisition systems can be designed such that the search space can be reduced by reducing computations in one domain (e.g., time or frequency) in favor of increasing computations in the other domain. However, such trade-offs may limit the usefulness of these techniques in circumstances where the search space is not large in the domain where the computations have been reduced. Therefore, non-trivial issues remain with respect to signal acquisition.

### Time/Frequency Search Space Reconfiguration

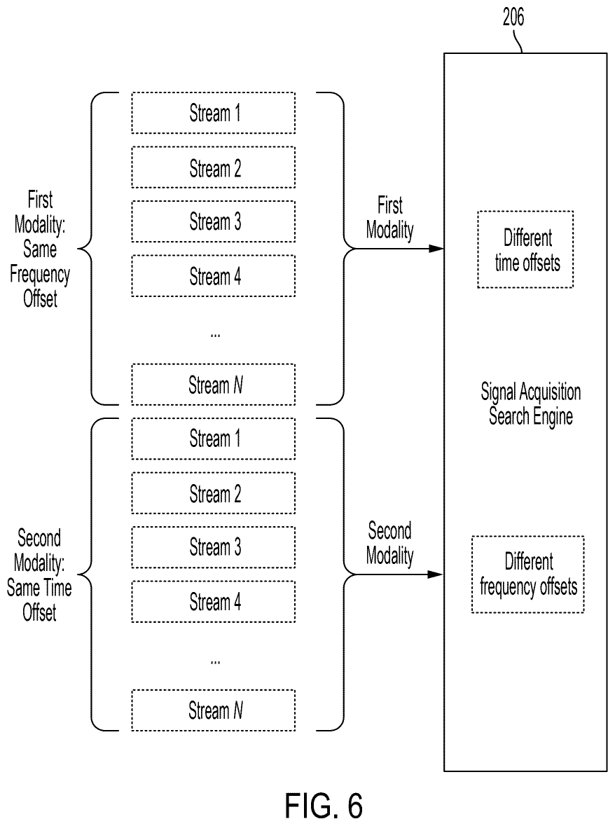

FIG. 6 illustrates example operation of the acquisition search engine 206, in accordance with an example of the present disclosure. The acquisition search engine 206 is implemented in a processor, such as an FPGA or ASIC, which can process up to N streams of input data at a sample rate of P samples per stream per scan of the input data. It will be understood that in some examples, there can be n streams of input data (e.g., where n=1, 2, 3, 4, 5, 6, etc.).

The acquisition search engine 206 is configured, in a first modality, to process six streams of data at the same frequency offset per scan of input data. In the first modality, each of the six streams are sampled P times at different time offsets, for a combined total of N×P samples per scan of input data. This provides a search over a wide range of time offsets.

The acquisition search engine 206 is configured, in a second modality, to process six streams of data at the same time offset per scan of input data. In the second modality, each of the six streams are sampled P times at different frequency offsets, for a combined total of N×P samples per scan of input data. This provides a search over a wide range of frequency offsets. The second modality is useful, for example, in applications where the time uncertainty is low relative to the Doppler frequency uncertainty, such as precision-guided munitions.

In some examples, the first modality and the second modality are configurable through software. For example, the acquisition controller 304 can be configured to send a mode selection signal to the acquisition processor 308 for selecting the first modality or the second modality.

In this manner, the acquisition search engine 206 can be configured to maximize resources for time offset hypothesis searching (e.g., in the first modality) where time uncertainty is high and frequency uncertainty is low, or to maximize resources for frequency offset searching (e.g., in the second modality) where frequency uncertainty is high and time uncertainty is low.

### Upper and Lower Sideband Processing for Non-M-Code Signals

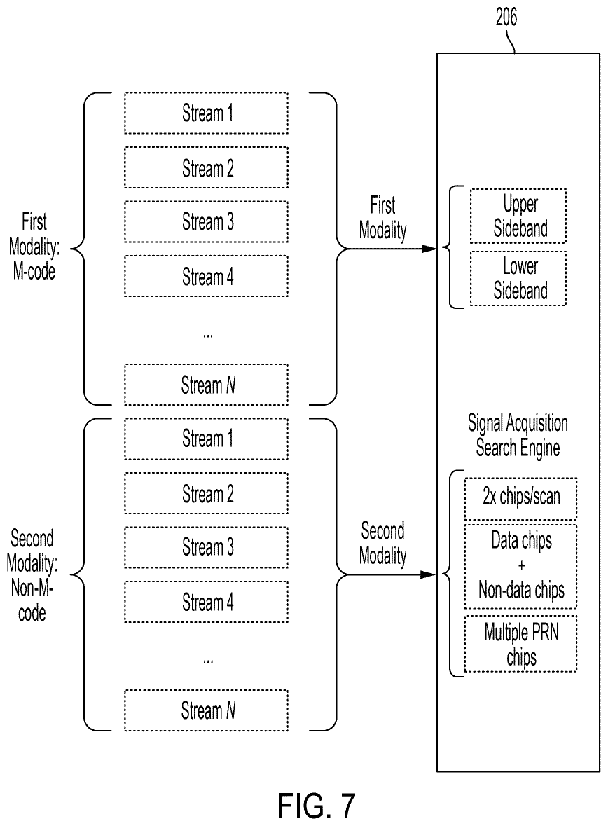

FIG. 7 illustrates example operation of the acquisition search engine 206, in accordance with another example of the present disclosure. The acquisition search engine 206 is implemented in a processor, such as an FPGA or ASIC, which can process multiple sideband signals. For example, the acquisition search engine 206 can process an M-code signal, which is utilized by the Global Positioning System (GPS). An M-code signal is designed for autonomous acquisition; that is, the receiver can decode the M-code signal to determine geographic location without acquiring any other signals. M-code signals are modulated on two widely spaced sidebands that separate the M-code signal from other signals within the same frequency carriers (e.g., civilian GPS). The acquisition search engine 206 correlates the two sideband signals separately and simultaneously, and then combines the results into an acquisition value.

However, in applications where M-code is not used, or for any signal that does not have two sidebands, half of the processing capacity in the acquisition search engine 206 may be underutilized. To increase the utilization of the acquisition search engine 206, the acquisition search engine 206 is configured, in a first modality, to process M-code signals (or other signals with two sidebands), and in a second modality, to process incoming data in a single band at a higher search rate. For example, in the second modality, the acquisition search engine 206 can double the search rate for non-M-code signals by utilizing both the upper sideband (first) and lower sideband (second) processing modules of the acquisition engine separately and simultaneously for the same center frequency (e.g., doubling the time offset from N×P samples per scan of input data to 2N×P samples per scan). In this example, the acquisition search engine 206 is configured to process and sort twice as much data than when processing an M-code signal.

In another example, in the second modality, the first and second processing modules of the acquisition search engine 206 can be configured to separately and simultaneously search data and dataless chips (pulses) for signals that have streams transmitted in quadrature, and then non-coherently combine those signals (e.g., to simultaneously search for multiple pseudorandom noise (PRN) codes). In this example, such signals can get ˜2 to 2.5 dB improvement. In yet another example, in the second modality, the acquisition search engine 206 can be configured to search multiple PRN codes of a signal at N×P samples per scan.

In some examples, the first modality and the second modality are configurable through software. For example, the acquisition controller 304 can be configured to send a mode selection signal to the acquisition processor 308 for selecting the first modality or the second modality.

### Extended Dwell Length

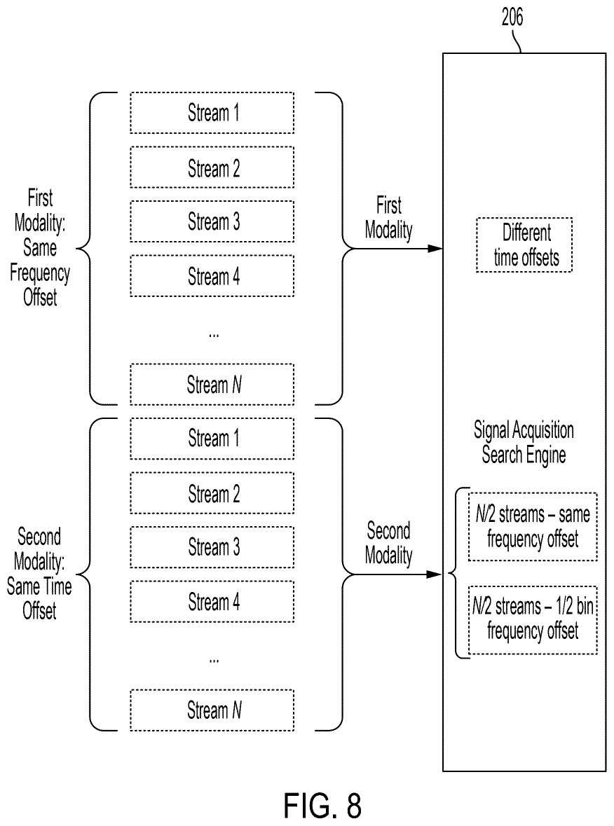

FIG. 8 illustrates example operation of the acquisition search engine 206, in accordance with another example of the present disclosure. The acquisition search engine 206 is implemented in a processor, such as an FPGA or ASIC, which can process up to six streams of input data at a sample rate of P samples per stream per scan of the input data.

The acquisition search engine 206 is configured, in a first modality, to process six streams of data at the same frequency offset per scan of input data. In the first modality, each of the six streams are sampled P times at different time offsets, for a combined total of 768 samples per scan of input data. This provides a search over a wide range of time offsets.

The acquisition search engine 206 is configured, in a second modality, to process six streams of data at the same time offset per scan of input data. In the second modality, three of the six streams are sampled P times at the same frequency offset, and three of the six streams are sampled P times at a one-half frequency bin (interval) offset, for a combined total of N×P samples per scan of input data. This provides a search over a wide range of frequency offsets. The second modality is useful, for example, in applications where searching with tighter frequency granularity permits twice the dwell length before code slide effects cause the detection to fall apart, which improves detectability in very high jamming environments by roughly 3 dB while lowering the search rate by one-half. Code slide effects are described in further detail below.

In some examples, the first modality and the second modality are configurable through software. For example, the acquisition controller 304 can be configured to send a mode selection signal to the acquisition processor 308 for selecting the first modality or the second modality.

In this manner, the acquisition search engine 206 can be configured to maximize resources for time offset hypothesis searching or to maximize resources for frequency offset searching where signal detectability is difficult.

In another example, a second code slide virtual tap former is implemented in the acquisition search engine 206 and set at a ½ bin offset. In this manner, dwells can be twice as long, which increases the detectability by 3 dB while maintaining the same search rate. Searching with tighter frequency granularity (e.g., ½ bin offsets) allows twice the dwell length before code slide effects affect detection, which would improve detectability in very high jamming environments by roughly 3 dB while keeping same search rate.

### Code slide Replication

Code slide can originate either from the satellite velocity Doppler shift or by the frequency error of the receiver. The effect of the frequency uncertainty on the acquisition process is realized when the receiver is generating code replicas to correlate against the incoming signal, as described above. The chipping rate of the incoming GPS signal is clocked at a predetermined rate that corresponds to the expected chipping rate of the signal. However, as the receiver clocks out internal chips to correlate against the incoming signal at the predetermined rate, any error in the receiver's knowledge of frequency (such as caused by Doppler shift) produces an internally generated chipping sequence that is either too slow or too fast.

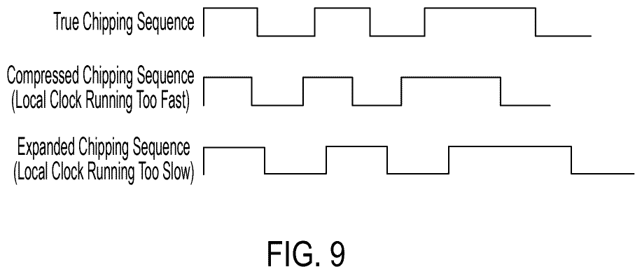

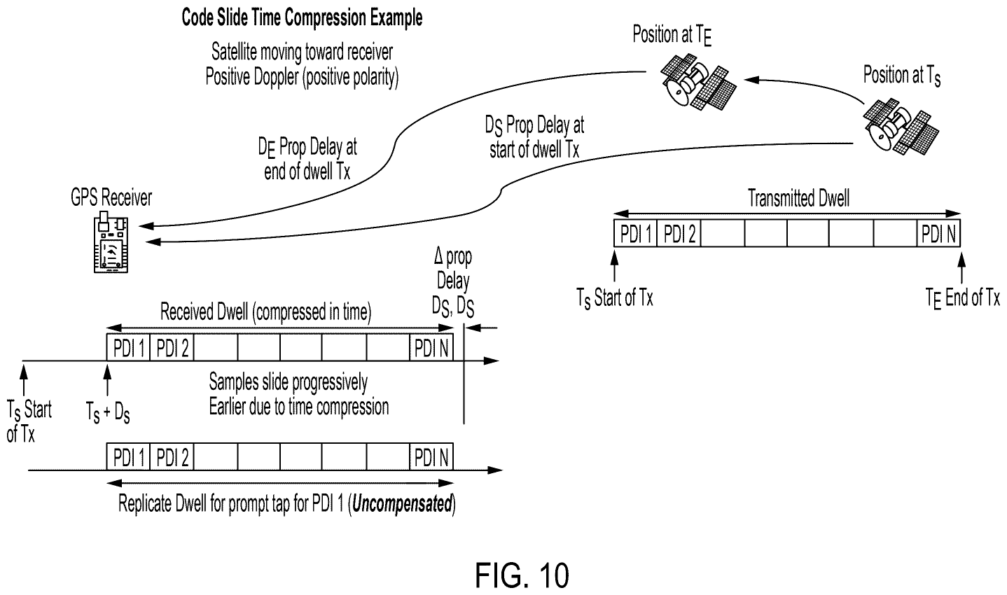

For example, FIG. 9 shows a comparison between the true chipping frequency of the incoming signal versus a compressed or expanded chipping sequence, where the clocking occurs too quickly or too slowly as a result of Doppler shift and/or frequency error. The satellite velocity also imparts a compression or expansion of the replicate chipping sequence, as shown in FIG. 10. The resulting misalignment between the predetermined chipping rate and the true chipping rate of the incoming signal leads to a condition referred to as code slide, where the code in the signal is misaligned with the chipping rate of the receiver.

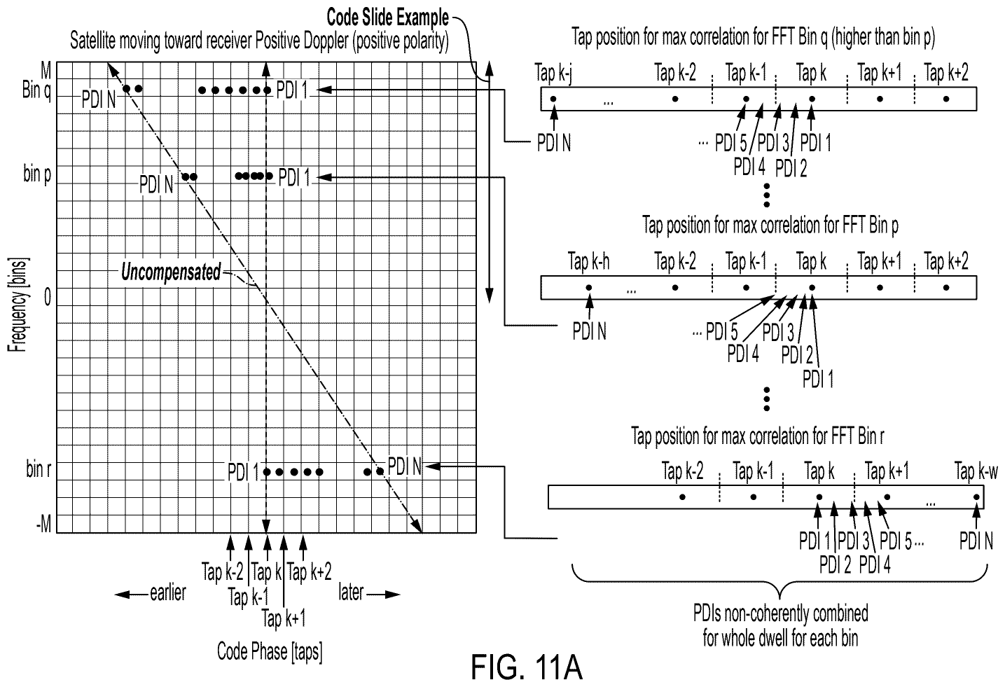

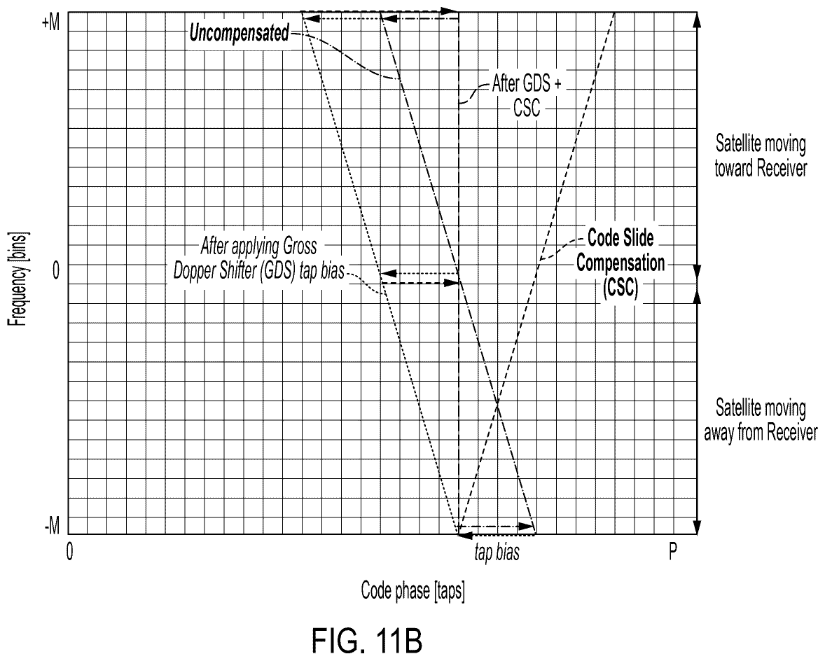

FIGS. 11A and 11B show an example of uncompensated code slide, in accordance with an example of the present disclosure. The effect of uncompensated code slide is that pre-detection integration (PDI) correlations, depending on the degree of Doppler shift, will slide (shift) out of a given code phase tap in the process stream 312 and leak correlation energy outside of the accumulator for that tap and into adjacent taps, which reduces correlation power, and hence detectability.

The code slide compensation done for each bin is only valid at the center of the bin. The code slide compensation is incorrect for any other frequency other than the center frequency of the bin. The code slide error is a linear function of the amount the true signal frequency is offset from center frequency of the bin. The worst case for the error occurs at the edges of the frequency bin, which limits the number of PDIs that can be combined in a dwell before the amount of code slide causes a sample misalignment in correlation peak for all subsequent PDIs, after which performance will degrade.

The code slide compensation is an accounting process that keeps track of which tap accumulation gets each subsequent PDI correlation added to it. As subsequent PDI accumulations occur earlier and earlier, they must be delayed an appropriate amount to be added to the correct tap. Taps at the end of a stream must be added to the beginning of the next stream. Taps at the end of a scan must be held to be added to the beginning of the next scan.

Once the code slide compensation is calculated, a set of virtual taps are created. These virtual taps are then integrated with a single scan. Each scan consists of N×P time offset hypotheses. The N×P taps are separated into N processing streams, each of which perform non-coherent integration.

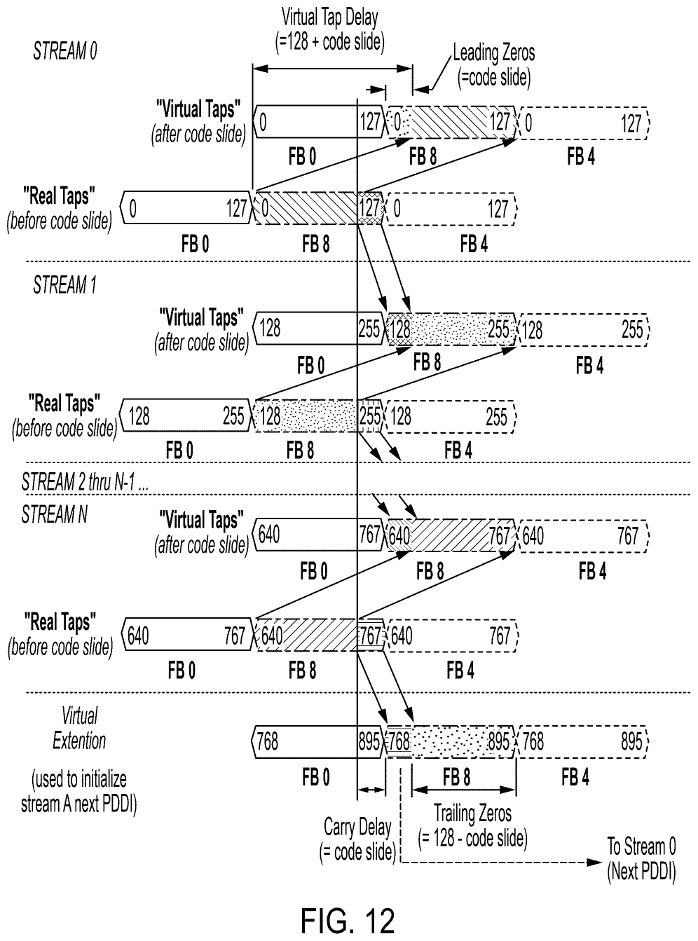

The virtual taps perform code slide compensation by transferring data points to different tap slides, even when that is between different process streams of the same scan, or between different scans. Their operation is diagrammed in FIG. 12, and described as follows.

FIG. 12 is a diagram of operation of code slide compensation, in accordance with an example of the present disclosure. A dwell accumulator cycles through each frequency bin. For each bin, the time offset hypotheses (TOH) run from 0 to P-1. If the calculated delay for a particular PDI exceeds the current TOH, then a carry enable flag is set high, which tells the virtual tap former that the input data should come from the next lower stream. In the case of stream 0, the input is zero when carry enable is high. The delay amount is the same for all streams for a given bin for a given PDI.

As the bin/tap combinations enter the dwell accumulator, they are in time division multiplex. The bin/tap combinations are given a variable delay according to the amount of code slide computed for the particular fast Fourier transform (FFT) bin and PDI count within the dwell interval. This compensates the code slide by delaying the taps within each particular frequency bin by the appropriate amount and sending the new virtual taps to the RSS function for integration. If the adjusted tap number would surpass the highest tap number (of a particular frequency bin), the tap is wrapped over into the initial taps of the next highest numbered processing stream. This places the tap at the beginning of the same frequency bin in the next (highest numbered) stream.

A virtual extension collects the tap overflow from the highest numbered stream and accumulates them over the dwell interval. On the next scan, the virtual extension feeds the values into stream 0 to initialize the RSS accumulator. This is done because tap numbers above the highest numbered tap (of a scan) are actually the tap position of lower numbered taps of the subsequent scan. Carrying over these overflow taps from one scan to the next (with the virtual tap extension) prevents any code offsets from being missed due to code slide crossing over the scan boundary.

### Example Processing Platform

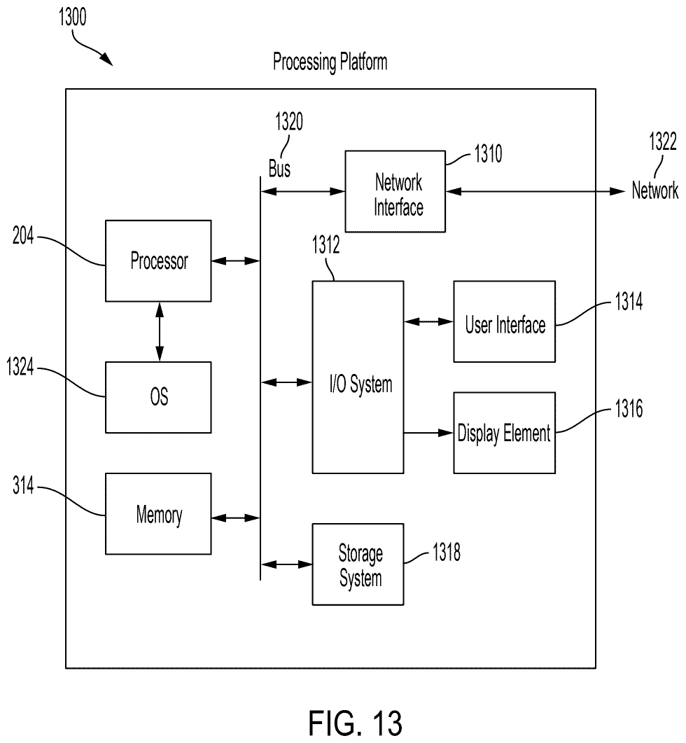

FIG. 13 is a block diagram of a processing platform 1300 configured to provide a system for signal acquisition, in accordance with an example of the present disclosure. In some examples, the platform 1300, or portions thereof, can be hosted on, or otherwise be incorporated into the electronic systems of a satellite receiver, including data communications systems, radar systems, computing systems, or embedded systems of any kind. The disclosed techniques can also be used to improve the reliability of satellite signal acquisition in other platforms including data communication devices, personal computers, workstations, laptop computers, tablets, touchpads, portable computers, handheld computers, cellular telephones, smartphones, or messaging devices.

In an example, the platform 1300 includes any combination of the processor 204, the memory 214, a network interface 1310, an input/output (I/O) system 1312, a user interface 1314, a display element 1316, and a storage system 1318. For example, the platform may include the receiver 104 of FIG. 1, including the memory 214 and the processor 204 with the signal acquisition search engine 206 of FIGS. 2 and 3. A bus and/or interconnect 1320 is provided to allow for communication between the various components listed above and/or other components of the platform 1300. The platform 1300 can be coupled to a network 1322 through the network interface 1310 to allow for communications with other computing devices, platforms, devices to be controlled, and/or other resources. Other componentry and functionality not reflected in FIG. 13 will be apparent in light of this disclosure, and it will be appreciated that other examples are not limited to any particular hardware configuration.

The processor 204 can be any suitable processor, and can include one or more coprocessors or controllers, such as an audio processor, a graphics processing unit, or hardware accelerator, to assist in the execution of mission software and/or any control and processing operations associated with the platform 1300. In some examples, the processor 204 is implemented as one or more processor cores. The processor core or cores can include any type of processor, such as, for example, a micro-processor, an embedded processor, a digital signal processor (DSP), a graphics processor (GPU), a network processor, a field programmable gate array (FPGA), or other computing or electronic device. The processor 204 can have multithreaded cores such that the processor 204 includes more than one hardware thread context or logical processor per core. In some examples, the processor 204 can be implemented as a complex instruction set computer (CISC) or a reduced instruction set computer (RISC) processor.

The memory 214 can be implemented using any suitable type of digital storage including, for example, a random-access memory (RAM). A random-access memory is any memory having storage locations, or cells, which can be read from and written to in any order. For example, the memory 214 can be implemented as a volatile memory device such as a RAM, dynamic RAM (DRAM), or static RAM (SRAM) device. The storage system 1318 can be implemented as a non-volatile storage device such as a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

In some examples, the processor 204 can be configured to execute an Operating System (OS) 1324, which can, for example, include any suitable operating system, such as Google Android (Google Inc., Mountain View, CA), Microsoft Windows (Microsoft Corp., Redmond, WA), macOS (Apple Inc., Cupertino, CA), Linux, or a real-time operating system (RTOS). In some examples, the processor 204 is a special purpose device configured to perform one or more of the functions variously described herein.

The network interface circuit 1310 can be any network chip or chipset that provides wired and/or wireless connection between other components of the platform 1300 and/or the network 1322, thereby enabling the platform 1300 to communicate with other local and/or remote computing systems, and/or other resources. Wired communication can include, for example, Ethernet. Wireless communication can include cellular communications including LTE (Long Term Evolution) and 5G, Wireless Fidelity (Wi-Fi), Bluetooth, and/or Near Field Communication (NFC). Wireless networks can include, for example, wireless local area networks, wireless personal area networks, wireless metropolitan area networks, cellular networks, and satellite networks.

The I/O system 1312 can be configured to interface between various I/O devices and other components of platform 1300. I/O devices can include, for example, the user interface 1314 and the display element 1316. The user interface 1314 can include input/output devices such as a touchpad, keyboard, and mouse, etc., for example, to allow the user to interact with the platform 1300 or components of the platform 1300. The display element 1316 can, for example, be configured to display information to a user. The I/O system 1312 can include a graphics component configured render graphics on the display element 1316. The graphics component can include, for example, a graphics processing unit or a visual processing unit. An analog or digital interface can be used to communicatively couple graphics subsystem and the display element. For example, the interface can include a high definition multimedia interface (HDMI), DisplayPort, wireless HDMI, and/or any other suitable interface using wireless high definition compliant techniques. In some examples, the graphics subsystem can be integrated into the processor 204 or another component (e.g., a graphics chipset) of the platform 1300.

It will be appreciated that in some examples, the various components of the platform 1300 can be combined or integrated in a system-on-a-chip (SoC) architecture. In some examples, the components can be hardware components, firmware components, software components or any suitable combination of hardware, firmware, or software.

In some examples, the platform 1300 can be implemented as a wireless system, a wired system, or a combination of both. When implemented as a wireless system, the platform 1300 can include components and interfaces suitable for communicating over a wireless shared media, such as one or more antennae, transmitters, receivers, transceivers, amplifiers, filters, control logic, and so forth. An example of wireless shared media can include portions of a wireless spectrum, such as the radio frequency spectrum and so forth. When implemented as a wired system, the platform 1300 can include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media can include a wire, cable metal leads, printed circuit board (PCB), backplane, switch fabric, semiconductor material, twisted pair wire, coaxial cable, fiber optics, and so forth.

Various examples of the present disclosure can be implemented using hardware elements, software elements, or a combination of both. Examples of hardware elements can include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software can include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements can vary in accordance with any number of factors, such as desired computational rate, power level, heat tolerances, processing cycle budget, input data rates, output data rates, memory resources, data bus speeds, and other design or performance constraints.

Some embodiments can be described using the expression “coupled” and “connected” along with their derivatives. These terms are not intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

Some examples disclosed herein can be implemented in various forms of hardware, software, firmware, and/or special purpose processors. For example, in one example, at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic.NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one example, the system can be hosted on a given website and implemented, for example, using JavaScript or another suitable browser-based technology. For instance, in some examples, the platform 1300 can leverage processing resources provided by a remote computer system accessible via the network 1322. The computer software applications disclosed herein can include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other examples are not limited to any particular hardware or software configuration. Thus, in some examples, the platform 1300 can include additional, fewer, or alternative subcomponents as those described above.

The non-transitory computer readable medium can include any suitable medium for storing digital information, such as a hard drive, a server, a flash memory, and/or random-access memory (RAM), or a combination of memories. In some examples, the components and/or modules disclosed herein can be implemented with hardware, including gate level logic such as a field-programmable gate array (FPGA), or alternatively, a purpose-built semiconductor such as an application-specific integrated circuit (ASIC). Still other examples can be implemented with a microcontroller having a number of input/output ports for receiving and outputting data, and a number of embedded routines for carrying out the various functionalities disclosed herein. It will be apparent that any suitable combination of hardware, software, and firmware can be used, and that other examples are not limited to any particular system architecture.

Some examples can be implemented, for example, using a machine readable medium or article that stores a set of instructions that, when executed by a machine, causes the machine to perform a method, process, and/or operations in accordance with the examples described herein. Such a machine can include, for example, any suitable processing platform, computing platform, computing device, processing device, computing system, processing system, computer, process, or the like, and can be implemented using any suitable combination of hardware and/or software. The machine readable medium or article can include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions can include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it will be appreciated that terms such as “processing,” “computing,” “calculating,” and “determining” refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system.

The terms “circuit” or “circuitry” can include, for example, hardwired circuitry, programmable circuitry, such as computer processors comprising one or more individual instruction processing cores, state machine circuitry, and/or firmware that stores instructions executed by programmable circuitry. The circuitry can include a processor and/or controller configured to execute one or more instructions to perform one or more operations described herein. The instructions can be implemented as, for example, an application, software, firmware, etc., configured to cause the circuit or circuitry to perform any of the operations or functions described herein. Software can be implemented as a software package, code, instructions, instruction sets and/or data recorded on a computer-readable storage device.

Software can be implemented to include any number of processes, and processes, in turn, can be implemented to include any number of threads, etc., in a hierarchical fashion. Firmware can be implemented as code, instructions or instruction sets and/or data that are hard-coded (e.g., nonvolatile) in memory devices. The circuit or circuitry can be implemented as part of a larger system, for example, an integrated circuit (IC), an application-specific integrated circuit (ASIC), a system-on-a-chip (SoC), desktop computers, laptop computers, tablet computers, servers, smartphones, etc. Other examples can be implemented as software executed by a programmable control device. In such cases, the terms “circuit” or “circuitry” are intended to include a combination of software and hardware such as a programmable control device or a processor capable of executing the software. As described herein, various examples can be implemented using hardware elements, software elements, or any combination thereof. Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, and/or chip sets.

### FURTHER EXAMPLE EXAMPLES

The following examples pertain to further examples, from which numerous permutations and configurations will be apparent.

Example 1 provides a signal acquisition device comprising an acquisition processor configured in a first modality, to correlate a set of RF signal samples across a plurality of time offset windows, wherein there are n streams and each of the n streams has a same frequency offset and a different time offset, and in a second modality, to correlate the set of RF signal samples across a plurality of frequency offset windows, wherein there are n streams and each of the n streams has a same time offset and a different frequency offset.

Example 2 includes the subject matter of Example 1, further comprising an acquisition code generator, wherein the acquisition processor is configured to correlate the set of RF signal sampled with one or more codes generated by the acquisition code generator.

Example 3 includes the subject matter of any one of Examples 1 and 2, wherein each scan of the set of RF signal samples includes P correlation taps, wherein a first one of the n streams includes correlation taps 0 to P-1, and wherein a second one of the n streams includes correlation taps P to 2P-1.

Example 4 includes the subject matter of Example 3, wherein each correlation tap is correlated over the set of RF signal samples per dwell period, and wherein the dwell period is an amount of time required to determine whether a code is present in the signal.

Example 5 includes the subject matter of any one of Examples 1-4, further comprising an acquisition controller configured to send a mode selection signal to the acquisition processor for selecting the first modality or the second modality.

Example 6 includes the subject matter of any one of Examples 1-5, further comprising an acquisition store configured to at least temporarily store the set of RF signal samples.

Example 7 provides a signal acquisition device comprising an acquisition processor configured in a first modality, to correlate a set of RF signal samples at a first rate, wherein the set of RF signal samples include M-code signals, and in a second modality, to correlate the set of RF signal samples at a second rate that is greater than the first rate, wherein the set of RF signal samples includes non-M-code signals.

Example 8 includes the subject matter of Example 7, wherein in the first modality the acquisition processor correlates each of the RF signal samples at two sideband frequencies separately and simultaneously using a first processor and a second processor, respectively.

Example 9 includes the subject matter of any one of Examples 7 and 8, wherein in the second modality the acquisition processor correlates two of the RF signal samples at a same center frequency separately and simultaneously using a first processor and a second processor, respectively.

Example 10 includes the subject matter of any one of Examples 7-9, further comprising an acquisition code generator, wherein the acquisition processor is configured to correlate the set of RF signal sampled with one or more codes generated by the acquisition code generator.

Example 11 includes the subject matter of any one of Examples 7-10, wherein the acquisition processor is configured to simultaneously search data and dataless chips for signals that have streams transmitted in quadrature, and to non-coherently combine the signals.

Example 12 includes the subject matter of any one of Examples 7-11, wherein the acquisition processor is configured to search the set of RF signals for multiple pseudorandom noise (PRN) codes.

Example 13 includes the subject matter of any one of Examples 7-12, further comprising an acquisition controller configured to send a mode selection signal to the acquisition processor for selecting the first modality or the second modality.

Example 14 includes the subject matter of any one of Examples 7-13, further comprising an acquisition store configured to at least temporarily store the set of RF signal samples.

Example 15 provides a signal acquisition device comprising an acquisition processor configured in a first modality, to correlate a set of RF signal samples across a plurality of time offset windows, wherein there are n streams and each of the n streams has a same frequency offset and a different time offset, and in a second modality, to correlate the set of RF signal samples across a plurality of frequency offset windows, wherein there are n streams, wherein one-half of the n streams have a same time offset and a first frequency offset, and wherein another one-half of the n streams have a same time offset and a second frequency offset that is one-half of a frequency bit offset from the first frequency offset.

Example 16 includes the subject matter of Example 15, further comprising an acquisition code generator, wherein the acquisition processor is configured to correlate the set of RF signal sampled with one or more codes generated by the acquisition code generator.

Example 17 includes the subject matter of any one of Examples 15 and 16, wherein each scan of the set of RF signal samples includes P correlation taps, wherein a first one of the n streams includes correlation taps 0 to P-1, and wherein a second one of the n streams includes correlation taps P to 2P-1.

Example 18 includes the subject matter of Example 17, wherein each correlation tap is correlated over the set of RF signal samples per dwell period, and wherein the dwell period is an amount of time required to determine whether a code is present in the signal.

Example 19 includes the subject matter of any one of Examples 15-18, further comprising an acquisition controller configured to send a mode selection signal to the acquisition processor for selecting the first modality or the second modality.

Example 20 includes the subject matter of any one of Examples 15-19, further comprising an acquisition store configured to at least temporarily store the set of RF signal samples.

Example 21 provides a radio frequency (RF) receiver including the signal acquisition device of any one of Examples 1 through 20.

Example 22 provides a satellite system including the signal acquisition device of any one of Examples 1 through 20.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A signal acquisition device comprising:
an acquisition processor configured
in a first modality, to correlate a set of RF signal samples across a plurality of time offset windows, wherein there are n streams and each of the n streams has a same frequency offset and a different time offset, and
in a second modality, to correlate the set of RF signal samples across a plurality of frequency offset windows, wherein there are n streams and each of the n streams has a same time offset and a different frequency offset.

2. The signal acquisition device of claim 1, further comprising an acquisition code generator, wherein the acquisition processor is configured to correlate the set of RF signal sampled with one or more codes generated by the acquisition code generator.

3. The signal acquisition device of claim 1, wherein each scan of the set of RF signal samples includes P correlation taps, wherein a first one of the n streams includes correlation taps 0 to P-1, and wherein a second one of the n streams includes correlation taps P to 2P-1.

4. The signal acquisition device of claim 3, wherein each correlation tap is correlated over the set of RF signal samples per dwell period, and wherein the dwell period is an amount of time required to determine whether a code is present in the signal.

5. The signal acquisition device of claim 1, further comprising an acquisition controller configured to send a mode selection signal to the acquisition processor for selecting the first modality or the second modality.

6. The signal acquisition device of claim 1, further comprising an acquisition store configured to at least temporarily store the set of RF signal samples.

7. A signal acquisition device comprising:
an acquisition processor configured
in a first modality, to correlate a set of RF signal samples at a first rate, wherein the set of RF signal samples include M-code signals, and
in a second modality, to correlate the set of RF signal samples at a second rate that is greater than the first rate, wherein the set of RF signal samples includes non-M-code signals.

8. The signal acquisition device of claim 7, wherein in the first modality the acquisition processor correlates each of the RF signal samples at two sideband frequencies separately and simultaneously using a first processor and a second processor, respectively.

9. The signal acquisition device of claim 7, wherein in the second modality the acquisition processor correlates two of the RF signal samples at a same center frequency separately and simultaneously using a first processor and a second processor, respectively.

10. The signal acquisition device of claim 7, further comprising an acquisition code generator, wherein the acquisition processor is configured to correlate the set of RF signal sampled with one or more codes generated by the acquisition code generator.

11. The signal acquisition device of claim 7, wherein the acquisition processor is configured to simultaneously search data and dataless chips for signals that have streams transmitted in quadrature, and to non-coherently combine the signals.

12. The signal acquisition device of claim 7, wherein the acquisition processor is configured to search the set of RF signals for multiple pseudorandom noise (PRN) codes.

13. The signal acquisition device of claim 7, further comprising an acquisition controller configured to send a mode selection signal to the acquisition processor for selecting the first modality or the second modality.

14. The signal acquisition device of claim 7, further comprising an acquisition store configured to at least temporarily store the set of RF signal samples.

15. A signal acquisition device comprising:
an acquisition processor configured
in a first modality, to correlate a set of RF signal samples across a plurality of time offset windows, wherein there are n streams and each of the n streams has a same frequency offset and a different time offset, and
in a second modality, to correlate the set of RF signal samples across a plurality of frequency offset windows, wherein there are n streams, wherein one-half of the n streams have a same time offset and a first frequency offset, and wherein another one-half of the n streams have a same time offset and a second frequency offset that is one-half of a frequency bit offset from the first frequency offset.

16. The signal acquisition device of claim 15, further comprising an acquisition code generator, wherein the acquisition processor is configured to correlate the set of RF signal sampled with one or more codes generated by the acquisition code generator.

17. The signal acquisition device of claim 15, wherein each scan of the set of RF signal samples includes P correlation taps, wherein a first one of the n streams includes correlation taps 0 to P-1, and wherein a second one of the n streams includes correlation taps P to 2P-1.

18. The signal acquisition device of claim 17, wherein each correlation tap is correlated over the set of RF signal samples per dwell period, and wherein the dwell period is an amount of time required to determine whether a code is present in the signal.

19. The signal acquisition device of claim 15, further comprising an acquisition controller configured to send a mode selection signal to the acquisition processor for selecting the first modality or the second modality.

20. The signal acquisition device of claim 15, further comprising an acquisition store configured to at least temporarily store the set of RF signal samples.
